(19) United States
(12) Patent Application Publication
(10) Pub. No.: US 2007/0074760 A1
(43) Pub. Date: Apr. 5, 2007

(54) Inflatable device

(76) Inventor: Hsin-Tsai Wu, Taipei City (TW)

Correspondence Address: TROP PRUNER & HU, PC, 1616 S. VOSS ROAD, SUITE 750, HOUSTON, TX, 77057-2631, US

(21) Appl. No.: 11/203,842

(22) Filed: Aug. 15, 2005

(51) Int. Cl. F16K 15/20; A47C 27/08

(52) U.S. Cl. 137/223; 5/706

(57) ABSTRACT

An inflatable device includes a tubular body fitted in a mouth of an inflatable body and having outer and inner end portions respectively defining an adaptor port and a valve seat therein. A valve member is movable between a closed position to be in air-tight engagement with the valve seat, and an open position to be disengaged from the valve seat so as to permit inflation and deflation of the inflatable body through the adaptor port. A plunger has a plunger rod connected to the valve member, and a plunger head such that when an air supplying tube of a pump is inserted into the adaptor port to force the plunger head to move toward the valve seat, the valve member is moved by the plunger rod to the open position. A biasing member is disposed to bias the plunger head to hold the valve member in the closed position.

### BACKGROUND OF THE INVENTION

1. Field of the Invention

This invention relates to an inflatable device, more particularly to an inflatable device which is adapted to be connected with a pump for inflating and deflating the inflatable device.

2. Description of the Related Art

Referring to FIG. 1, a conventional inflatable device 1, such as an inflatable mattress, is shown to include an air inlet port 11 and an air outlet port 12. A pump 2 generally has an air supplying port 21 connected to the air inlet port 11 for inflating the inflatable device 1. The user has to grip the pump 2 to maintain the connection between the air supplying port 21 and the air inlet port 11 during inflation, thereby resulting in inconvenience during inflation. In addition, it is desirable to improve the speed of inflating the inflatable device 1, and the air-tightness of the air inlet port 11 when inflation is completed.

### SUMMARY OF THE INVENTION

The object of the present invention is to provide an inflatable device which is easily connected to a pump for inflating and deflating the inflatable device, which can be inflated and deflated quickly, and which has an improved air-tightness when inflation is completed.

According to this invention, the inflatable device includes an inflatable body which defines an inflatable chamber therein, and which has an inner peripheral edge defining a mouth that is in fluid communication with the inflatable chamber. A tubular body has a tubular wall which is fitted in the mouth, and which includes an outer end portion that is secured to the inner peripheral edge, an inner end portion that is opposite to the outer end portion along an axis and that is disposed in the inflatable chamber, and an intermediate portion that is interposed between the outer and inner end portions. The outer end portion, the inner end portion, and the intermediate portion respectively define an adaptor port, a valve seat, and a conduit therein. The conduit is in fluid communication with the inflatable chamber through the valve seat. The adaptor port is adapted to be connected to an air supplying tube of a pump. An abutment mount is disposed on the tubular wall between the intermediate portion and the inner end portion, and extends radially and towards the axis. A valve member is movable relative to the inner end portion of the tubular body along the axis between a closed position, where the valve member is in air-tight engagement with the valve seat to shut off fluid communication between the conduit and the inflatable chamber, and an open position, where the valve member is disengaged from the valve seat to allow fluid communication between the conduit and the inflatable chamber so as to permit air to enter the inflatable chamber or to permit air to escape from the inflatable chamber through the adaptor port. A plunger has a plunger rod which extends along the axis through the abutment mount and which has an end connected to the valve member, and a plunger head which is connected to an opposite end of the plunger rod such that when the air supplying tube is inserted into the adaptor port to force the plunger head to move toward the abutment mount, the valve member is moved by the plunger rod from the closed position to the open position. A biasing member is disposed between the plunger head and the abutment mount to bias the plunger head to move away from the abutment mount so as to permit the valve member to be held in the closed position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional inflatable device and a pump used therewith;

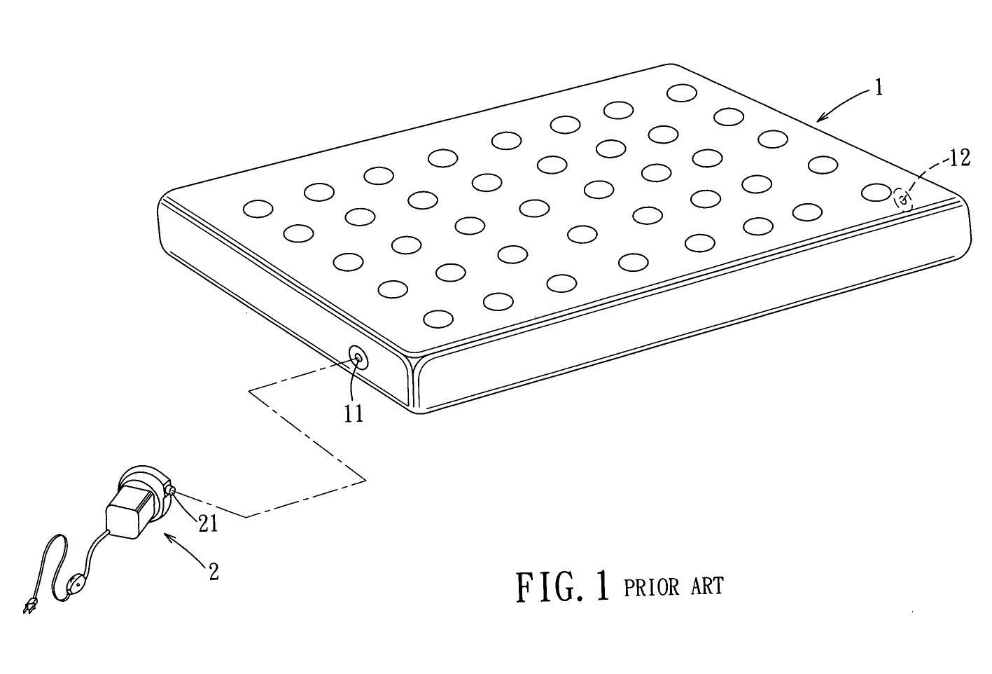

FIG. 2 is an exploded perspective view of the preferred embodiment of an inflatable device according to this invention;

FIG. 3 is a fragmentary sectional view of the preferred embodiment in a valve-closed state;

FIG. 4 is a fragmentary perspective view of the preferred embodiment and a pump used therewith;

FIG. 5 is an end view of the preferred embodiment;

FIG. 6 is a fragmentary sectional view of the preferred embodiment in a valve-open state; and

FIG. 7 is a fragmentary perspective view of the preferred embodiment and another pump used therewith.

### DETAILED DESCRIPTION OF THE PREFERRED EMBODIMENT

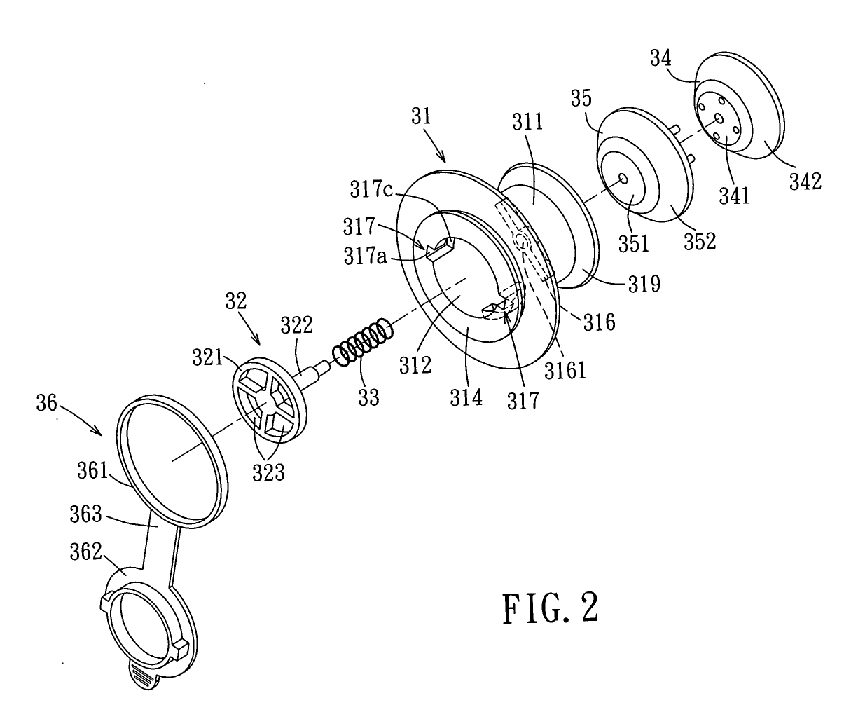

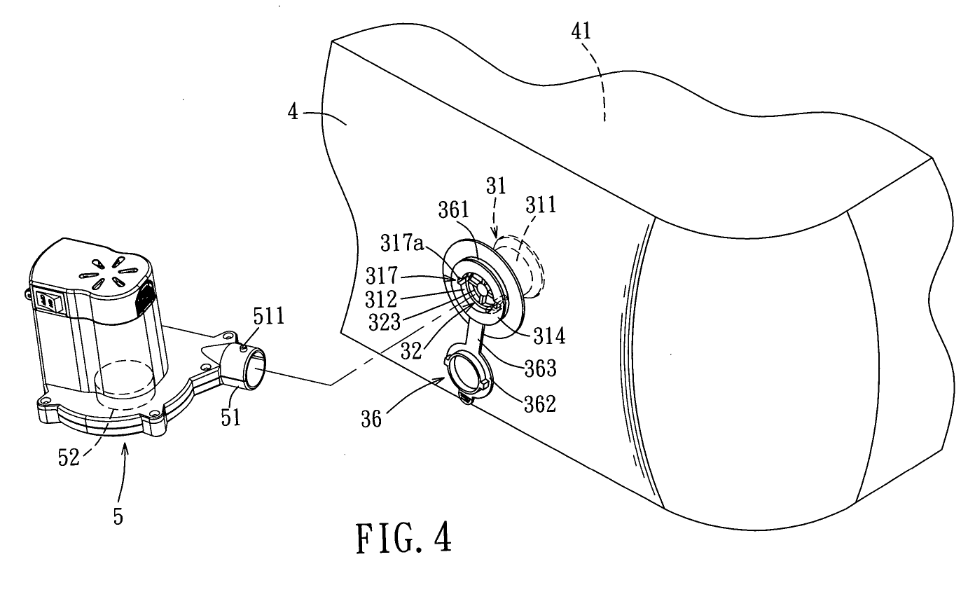

Referring to FIGS. 2 to 4, the preferred embodiment of an inflatable device according to the present invention is shown to be adapted to be connected to a pump 5 for inflating and deflating the inflatable device. The pump 5 includes an air supplying tube 51 and an air receiving portion 52 which is connected to an air source (not shown). The inflatable device is shown to comprise an inflatable body 4 in the form of a mattress, a tubular body 31, a valve member 34, an elastomeric disk 35, a plunger 32, a biasing member 33, and a cap member 36.

The inflatable body 4 defines an inflatable chamber 41 therein, and has an inner peripheral edge defining a mouth 42 that is in fluid communication with the inflatable chamber 41.

The tubular body 31 has a tubular wall which is fitted in the mouth 42, and which includes an outer end portion 314 that is secured to the inner peripheral edge of the inflatable body 4, an inner end portion 318 that is opposite to the outer end portion 314 along an axis and that is disposed in the inflatable chamber 41, and an intermediate portion 311 that is interposed between the outer and inner end portions 314, 318. The outer end portion 314, the inner end portion 318, and the intermediate portion 311 respectively define an adaptor port 312, a valve seat 313, and a conduit 315 therein. The conduit 315 is in fluid communication with the inflatable chamber 41 through the valve seat 313. The adaptor port 312 is adapted to be connected to the air supplying tube 51 of the pump 5. The tubular wall of the tubular body 31 further includes a flared portion 319 which diverges from the inner end portion 318 away from the intermediate portion 311. An abutment mount 316, which is in the form of a crosspiece, is disposed on the tubular wall of the tubular body 31 between the intermediate portion 311 and the inner end portion 318, and which extends radially and towards the axis to terminate at a hole 3161.

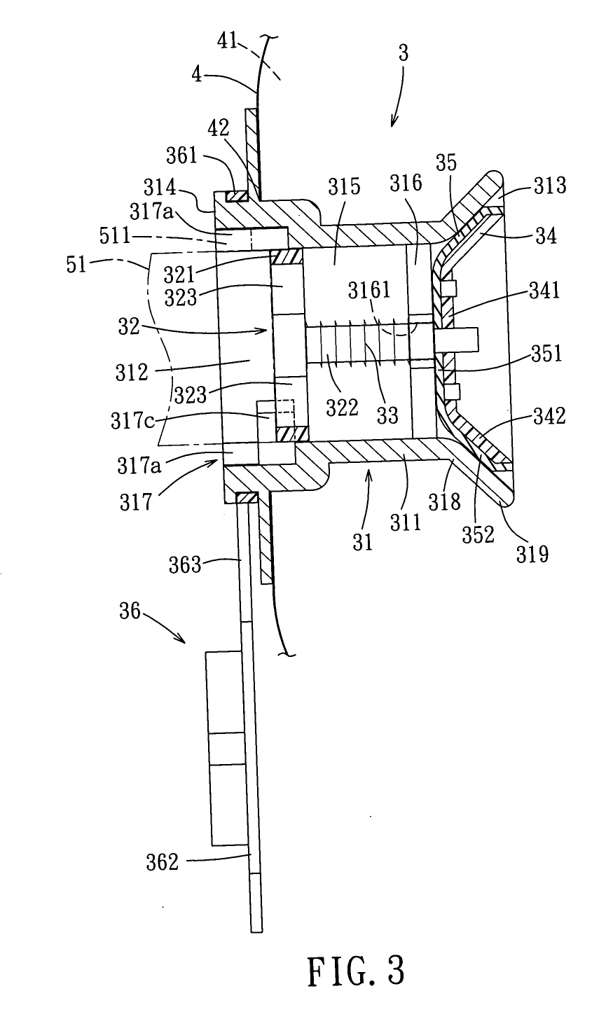

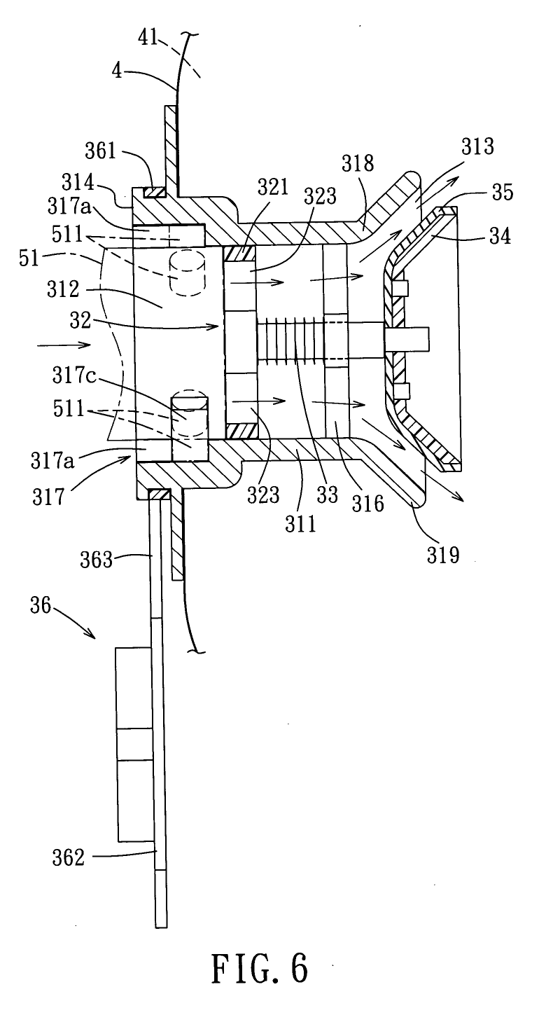

The valve member 34 has a base 341 which has a periphery surrounding the axis, and a skirt portion 342 which extends from the periphery of the base 341 radially and along the axis. The elastomeric disk 35 has central and surrounding regions 351, 352 attached to the base 341 and the skirt portion 342, respectively. The valve member 34, as well as the elastomeric disk 35, is movable relative to the inner end portion 318 of the tubular body 31 along the axis between a closed position, as shown in FIG. 3, where the central region 351 is disposed between the abutment mount 316 and the base 341 of the valve member 34, and where the surrounding region 352 is disposed between the skirt portion 342 of the valve member 34 and the flared portion 319 so as to ensure air-tight engagement between the valve member 34 and the valve seat 313, thereby shutting off the fluid communication between the conduit 315 and the inflatable chamber 41, and an open position, as shown in FIG. 6, where the valve member 34 and the elastomeric disk 35 are disengaged from the valve seat 313 to allow the fluid communication between the conduit 315 and the inflatable chamber 41 so as to permit air to enter the inflatable chamber 41 or to permit escape of air from the inflatable chamber 41 through the adaptor port 312.

The plunger 32 has a plunger rod 322 which extends along the axis through the hole 3161 in the abutment mount 316 and which has an end connected to the valve member 34 and the elastomeric disk 35, and a plunger head 321 which is connected to an opposite end of the plunger rod 322 and which is configured to be in a sliding engagement with the intermediate portion 311 of the tubular body 31 so as to guide movement of the plunger 32 along the axis. The plunger head 321 has a plurality of openings 323 formed therethrough for passage of air.

The biasing member 33 is a coil spring which surrounds the plunger rod 322 and which abuts against the plunger head 321 and the abutment mount 316 to bias the plunger head 321 to move away from the abutment mount 316 so as to permit the valve member 34 to be held in the closed position.

The cap member 36 has a connected end 361 which is connected to the outer end portion 314, a cap end 362 opposite to the connected end 361, and a flexible portion 363 interposed between the connected and cap ends 361, 362 so as to permit the cap end 362 to be placed between a corking position where the cap end 362 corks up the adaptor port 312, and a communicating position where the cap end 362 is disengaged from the outer end portion 314.

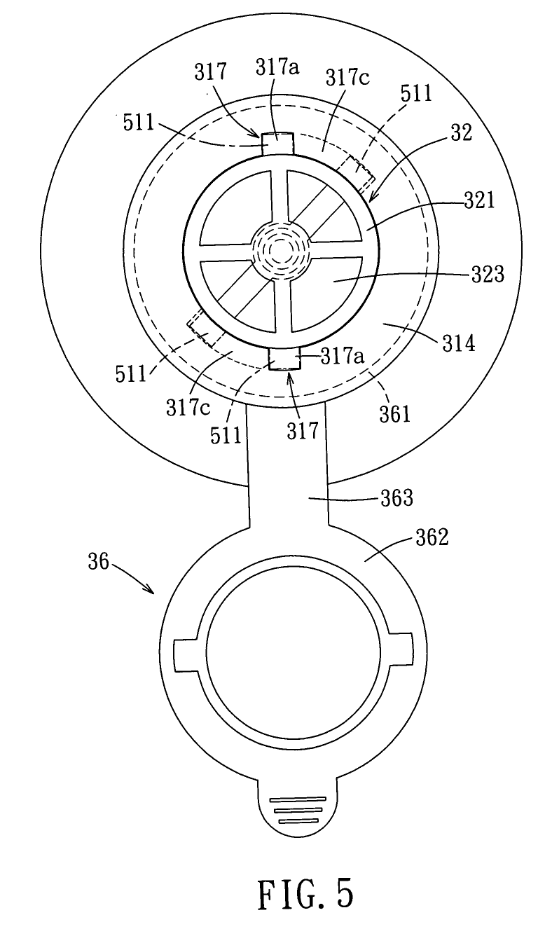

With reference to FIGS. 2, 4, 5 and 6, the preferred embodiment further includes a retaining member which includes a pair of retaining grooves 317 and a pair of engaging pegs 511. Each of the retaining grooves 317 is formed in the outer end portion 314 of the tubular body 31 to be communicated with the adaptor port 312, and has an axial groove segment (317a) extending axially, and a retaining segment (317c) extending circumferentially from the axial groove segment (317a). Each of the engaging pegs 511 is adapted to be disposed on the air supplying tube 51 of the pump 5, and is engageable in the respective retaining groove 317 once the air supplying tube 51 is inserted into the adaptor port 312 through guided movement of the engaging peg 511 in the axial groove segment (317a) of the respective retaining groove 317 such that when the air supplying tube 51 is turned about the axis, the engaging peg 511 is brought to engage the retaining segment (317c) of the respective retaining groove 317, thereby arresting axial movement of the air supplying tube 51 of the pump 5 relative to the outer end portion 314 of the tubular body 31.

When the air supplying tube 51 is inserted into the adaptor port 312 against the biasing action of the biasing member 33 to force the plunger head 321 to move toward the abutment mount 316, as shown in FIG. 6, the valve member 34 is moved by the plunger rod 322 from the closed position to the open position. When the air supplying tube 51 is subsequently turned about the axis to bring the engaging pegs 511 to engage the retaining segment (317c) so as to arrest the axial movement of the air supplying tube 51 relative to the tubular body 31, the valve member 34 is arrested in the open position to facilitate inflation or deflation of the inflatable body 4. Moreover, since the valve member 34 has the base 341 and the skirt portion 342 attached to the elastomeric disk 35, the air-tightness of the valve seat 313 is improved. Furthermore, since the air supplying tube 51 can be easily connected to the adaptor port 312, and since the plunger rod 322 of the plunger 32 can be dimensioned to be relatively small so that the conduit 315 has a relatively large space for passage of air therethrough, the inflation and deflation operations can be quickly and easily conducted. In addition, as the biasing member 33 surrounds the plunger rod 322 and is disposed between the plunger head 321 and the abutment mount 316, the construction of the tubular body 31, the plunger 32 and the valve member 34 can be made compact.

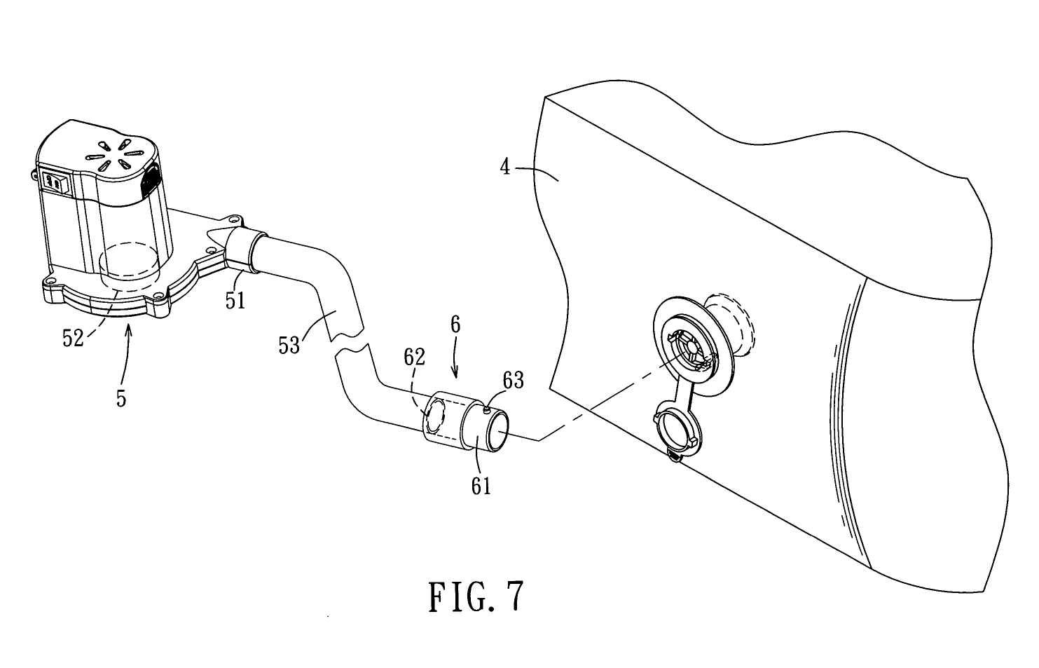

Alternatively, referring to FIG. 7, the inflatable device of the preferred embodiment according to this invention may also be used with another type of the pump 5 which has an air supplying tube 51 without engaging pegs. Thus, a hose 53 is required to connect the air supplying tube 51 of the pump 5 with an adaptor member 6. The adaptor member 6 has a peripheral wall 61 defining a duct 62 therein, and an engaging peg 63 formed on the peripheral wall 61 to serve as the engaging peg 511 described above.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. An inflatable device adapted to be connected with an air supplying tube of a pump for inflating and deflating said inflatable device, said inflatable device comprising:
an inflatable body which defines an inflatable chamber therein, and which has an inner peripheral edge defining a mouth that is in fluid communication with said inflatable chamber;
a tubular body having a tubular wall which is fitted in said mouth, and which includes an outer end portion that is secured to said inner peripheral edge, an inner end portion that is opposite to said outer end portion along an axis and that is disposed in said inflatable chamber, and an intermediate portion that is interposed between said outer and inner end portions, said outer end portion, said inner end portion, and said intermediate portion respectively defining an adaptor port, a valve seat, and a conduit therein, said conduit being in fluid communication with said inflatable chamber through said valve seat, said adaptor port being adapted to be connected to the air supplying tube of the pump;
an abutment mount which is disposed on said tubular wall between said intermediate portion and said inner end portion and which extends radially and towards the axis;
a valve member which is movable relative to said inner end portion of said tubular body along the axis between a closed position, where said valve member is in air-tight engagement with said valve seat to shut off fluid communication between said conduit and said inflatable chamber, and an open position, where said valve member is disengaged from said valve seat to allow fluid communication between said conduit and said inflatable chamber so as to permit air to enter said inflatable chamber or to permit air to escape from said inflatable chamber through said adaptor port;
a plunger having a plunger rod which extends along the axis through said abutment mount and which has an end connected to said valve member, and a plunger head which is connected to an opposite end of said plunger rod such that when the air supplying tube is inserted into said adaptor port to force said plunger head to move toward said abutment mount, said valve member is moved by said plunger rod from the closed position to the open position; and
a biasing member disposed between said plunger head and said abutment mount to bias said plunger head to move away from said abutment mount so as to permit said valve member to be held in the closed position.

2. The inflatable device of claim 1, further comprising a retaining member which is adapted to arrest axial movement of the air supplying tube of the pump relative to said outer end portion of said tubular wall when the air supplying tube is inserted into said adaptor port.

3. The inflatable device of claim 2, wherein said releasably retaining member includes
a retaining groove which is formed in said outer end portion of said tubular wall to be communicated with said adaptor port, and which has an axial groove segment extending axially, and a retaining segment extending circumferentially from said axial groove segment, and
an engaging peg which is adapted to be disposed on the air supplying tube, and which is engageable in said retaining groove once the air supplying tube is inserted into said adaptor port through guided movement of said engaging peg in said axial groove segment such that when the air supplying tube is turned about the axis, said engaging peg is brought to engage said retaining segment, thereby arresting the air supplying tube in the open position.

4. The inflatable device of claim 1, wherein said plunger head is configured to be in a sliding engagement with said intermediate portion of said tubular wall so as to guide movement of said plunger along the axis.

5. The inflatable device of claim 1, wherein said tubular wall further includes a flared portion which diverges from said inner end portion away from said intermediate portion, said valve member having a base which has a periphery surrounding the axis and which is configured to abut against said abutment mount in the closed position, and a skirt portion which extends from said periphery of said base radially and along the axis such that when said valve member is in the closed position, said skirt portion is in air-tight engagement with said flared portion.

6. The inflatable device of claim 5, further comprising an elastomeric disk which includes a central region disposed between said abutment mount and said base of said valve member, and a surrounding region disposed between said skirt portion and said flared portion so as to ensure air-tight engagement of said valve member with said valve seat when said valve member is in the closed position.

7. The inflatable device of claim 1, wherein said abutment mount is in form of a crosspiece which extends from said tubular wall radially towards the axis to terminate at a hole for passage of said plunger rod therethrough.

8. The inflatable device of claim 1, wherein said biasing member is a coil spring which surrounds said plunger rod and which abuts against said plunger head and said abutment mount.

9. The inflatable device of claim 1, further comprising a cap member which has a connected end connected to said outer end portion, a cap end opposite to said connected end, and a flexible portion interposed between said connected and cap ends so as to permit said cap end to be placed between a corking position where said cap end corks up said adaptor port, and a communicating position where said cap end is disengaged from said outer end portion.
